(19) United States
(12) Patent Application Publication
(10) Pub. No.: US 2005/0234165 A1
(43) Pub. Date: Oct. 20, 2005

(54) Tyre having a high wear resistance, tread band and elastomeric composition used therein

(76) Inventors: Stephane Schaal, Brugg (CH); Mario Martin, Sesto San Giovanni (IT); Luigi Migliarini, Monza (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/509,851

(22) PCT Filed: Apr. 23, 2002
(86) PCT No.: PCT/EP02/04455

§ 371 Date: May 6, 2005

(51) Int. Cl. C08K 5/20; C08K 3/26; C08K 3/04; C08K 3/34

(52) U.S. Cl. 524/210; 523/149; 524/492; 524/495; 524/425

(57) ABSTRACT

An elastomeric composition includes at least one diene elastomeric polymer; at least one reinforcing filler; from 0.05 phr to 10 phr of zinc oxide; from 0.1 phr to 20 phr of at least one fatty acid amide; and from 0.1 phr to 15 phr of at least one zinc salt of a carboxylic acid of formula R—COOH. R is selected from linear or branched C₁-C₂₄ alkyl groups, linear or branched C₂-C₂₄ alkenyl groups, C₅-C₂₄ cycloalkyl groups, C₆-C₂₄ aryl groups, C₇-C₂₄ alkylaryl or arylalkyl groups. A tyre for a vehicle wheel includes a carcass structure, belt structure, tread band, and pair of sidewalls. At least one tyre structural element includes a crosslinked elastomeric material obtained by crosslinking the elastomeric composition. The at least one structural element including the crosslinked elastomeric material may be the tread band. A related tyre tread band and crosslinked elastomeric manufactured product are also disclosed.

The present invention relates to a tyre for vehicle wheels, to a tread band and to a crosslinkable elastomeric composition.

More particularly, the present invention relates to a tyre for vehicle wheels comprising at least one structural element made of crosslinked elastomeric material including at least one fatty acid amide and at least one zinc salt of a carboxylic acid.

The present invention moreover relates to a tread band including a crosslinkable elastomeric composition comprising at least one fatty acid amide and at least one zinc salt of a carboxylic acid, and also to an elastomeric composition comprising at least one fatty acid amide and at least one zinc salt of a carboxylic acid.

In the rubber industry, in particular in the industry for production of vehicle wheel tyres, use of elastomeric compositions is known in which reinforcing fillers are incorporated into the elastomeric base for the purpose of improving the features of the crosslinked manufactured article, in particular mechanical properties and abrasion resistance.

Due to its high reinforcing power, carbon black is the most widely used reinforcing filler. However, carbon black gives the crosslinked manufactured article marked hysteresis features, i.e. an increase in the heat dissipated under dynamic conditions which, as known, in the case of a tyre, gives rise to an increase of the rolling resistance of the tyre itself. This leads about an increase in the vehicle fuel consumption and, consequently, an increase both in the locomotion costs and in air pollution. An attempt to reduce these negative effects can be made by using smaller amounts of carbon black and/or a carbon black having a reduced surface area. This however, inevitably leads to a reduction in the reinforcing action which worsen mechanical properties and abrasion resistance of the finished product. On the other hand, when carbon black is used in an excessive amount, a problem arises in that the elastomeric compositions become excessively hard to cause difficulty in industrial processing, the dispersion of carbon black in the elastomeric compositions becomes inferior and, also in this case, a reduction in the reinforcing action is obtained.

To overcome said drawbacks, the so-called “white” reinforcing fillers such as gypsum, talc, kaolin, bentonite, titanium dioxide, silicates of various types and, above all, silica, are usually used, in total or partial replacement for the carbon black. In this connection, reference can be made to European Patent EP 501,227, for example. However, also in this case there are a series of drawbacks essentially related to the poor affinity of silica with respect to the elastomers commonly used in the production of tyres. Moreover, dispersion of silica in the elastomeric compositions becomes inferior and the high viscosity of the same cause difficulty in industrial processing.

To obtain a good degree of dispersion of said reinforcing fillers, both carbon black and silica, processing aids such as, for example, aromatic oil, are usually added to the elastomeric compositions. In some instances, however, attemps to include large amounts of oils into elastomeric compositions result in loss of other desirable properties such as, for example, tensile strength, wear resistance and heat resistance.

Moreover, in the case of silica, to increase affinity of silica for the elastomeric matrix, appropriate coupling agents are currently used such as, for example, sulphur-containing organosilane products having two different groups: a first group which is able to interact with the silanol groups present on the silica surface, a second group able to promote interaction with the sulphur-vulcanizable elastomeric polymers. Use of said coupling agents however, limits the maximum temperature that can be achieved during the mixing and thermomechanical-working operations of the elastomeric compositions, under penalty of an irreversible thermal degradation of the coupling agent. In addition, the high cost of said coupling agents adversely affects the cost of the finished product.

Other attempts have been made in the prior art to improve the dispersability of said reinforcing fillers into the elastomeric compositions.

For example, patent application FR 2,790,478 describes a rubber composition comprising 100 part by weight of rubber and at least 20 part by weight of silica and at least an amide-containing compound, a phenolic resin and a hardening agent for said resin. Said amide-containing compound can be selected from: formamide, acetamide, propionamide, butyramide, capronamide, acid lauric amide, stearamide, succinamide, urea, dimetilurea, benzamide, benzanilide, N-ciclohexylpropionamide, N,N-di(hydroxyethylol)amide, ε-caprolactame, butyranilide, succinimide, and the like. Said rubber composition, thanks to a better dispersion of the silica in the same, is said to give a crosslinked rubber composition having an improved tearing resistance.

U.S. Pat. No. 5,962,562 describes a method for processing a rubber composition which comprises mixing (i) 100 parts by weight of at least one elastomer containing olefinic unsaturation selected from the group consisting of natural rubber and conjugated diene homopolymers and copolymers and from copolymers of at least one conjugated diene and aromatic vinyl compound; with (ii) 0.05 to 10 parts by weight of N-(4-hydroxy-phenyl)stearamide. The presence of said N-(4-hydroxy-phenyl)stearamide in a rubber composition is said to provide lower minimum Rheometer torque which would indicate less work input required during Banbury mixing and an improved processing composition. Moreover, said stearamide, also improves flex properties and abrasion resistance of the crosslinked rubber composition.

U.S. Pat. No. 6,333,375 describes a rubber composition comprising 100 part by weight of a diene rubber component, 10 to 200 part by weight of a reinforcing agent, and 0.1 to 15 parts by weight of a fatty acid salt. Preferably, said fatty acid salt is a metal salt of a fatty acid. Said rubber composition is said to give a crosslinked rubber composition having an improved heat build-up, tensile strength, abrasion resistance and processability.

The Applicant has now found that it is possible to obtain crosslinkable elastomeric compositions capable of being used advantageously in the production of crosslinked manufactured products, in particular in the production of tyre for vehicle wheels, by using a fatty acid amide and at least one zinc salt of a carboxylic acid. In this way, it is possible to obtain a crosslinkable elastomeric composition which exhibits an improved processability and which gives a crosslinked elastomeric manufactured product endowed with an improved abrasion resistance. Moreover, said properties have been achieved without impairing the mechanical properties of said crosslinked manufactured product.

According to a first aspect, the present invention thus relates to a tyre for vehicle wheels, comprising at least one structural element including a crosslinked elastomeric material obtained by crosslinking an elastomeric composition comprising:
(a) at least one diene elastomeric polymer;
(b) at least one reinforcing filler;
(c) from 0.05 phr to 10 phr of zinc oxide;
(d) from 0.1 phr to 20 phr of at least one fatty acid amide;
(e) from 0.1 phr to 15 phr of at least one zinc salt of a carboxylic acid of formula R—COOH, wherein R is selected from linear or branched C₁-C₂₄ alkyl groups, linear or branched C₂-C₂₄ alkenyl groups, C₅-C₂₄ cycloalkyl groups, C₆-C₂₄ aryl groups, C₇-C₂₄ alkylaryl or arylalkyl groups.

According to one preferred embodiment, the present invention relates to a tyre for vehicle wheels, comprising:
a carcass structure with at least one carcass ply shaped in a substantially toroidal configuration, the opposite lateral edges of which are associated with respective right-hand and left-hand bead wires, each bead wire being enclosed in a respective bead;
a belt structure comprising at least one belt strip applied in a circumferentially external position relative to said carcass structure;
a tread band superimposed circumferentially on said belt structure;
a pair of side walls applied laterally on opposite sides relative to said carcass structure; in which said structural element which includes said elastomeric composition is the tread band.

According to a further aspect, the present invention relates to a tyre tread band including a crosslinkable elastomeric composition comprising:
(a) at least one diene elastomeric polymer;
(b) at least one reinforcing filler;
(c) from 0.05 phr to 10 phr of zinc oxide;
(d) from 0.1 phr to 20 phr of at least one fatty acid amide;
(e) from 0.1 phr to 15 phr of at least one zinc salt of a carboxylic acid of formula R—COOH, wherein R is selected from linear or branched C₁-C₂₄ alkyl groups, linear or branched C₂-C₂₄ alkenyl groups, C₅-C₂₄ cycloalkyl groups, C₆-C₂₄ aryl groups, C₇-C₂₄ alkylaryl or arylalkyl groups.

For the purposes of the present description and of the claims, the term “phr” means the parts by weight of a given component of the elastomeric composition per 100 parts by weight of the elastomeric polymer.

According to a further aspect, the present invention relates to an elastomeric composition comprising:
(a) at least one diene elastomeric polymer;
(b) at least one reinforcing filler;
(c) from 0.05 phr to 10 phr of zinc oxide;
(d) from 0.1 phr to 20 phr of at least one fatty acid amide;
(e) from 0.1 phr to 15 phr of at least one zinc salt of a carboxylic acid of formula R—COOH, wherein R is selected from linear or branched C₁-C₂₄ alkyl groups, linear or branched C₂-C₂₄ alkenyl groups, C₅-C₂₄ cycloalkyl groups, C₆-C₂₄ aryl groups, C₇-C₂₄ alkylaryl or arylalkyl groups.

According to a further aspect, the present invention relates to a crosslinked elastomeric manufactured product obtained by crosslinking the abovementioned elastomeric composition.

According to one preferred embodiment, the zinc oxide (c) is added to the elastomeric composition in an amount of from 0.1 phr to 6.0 phr, preferably from 0.5 phr to 5.0 phr.

According to one preferred embodiment, the fatty acid amide (d) is added to the elastomeric composition in an amount of from 0.5 phr to 10 phr, preferably from 2.0 phr to 6.0 phr.

According to one preferred embodiment, the zinc salt of a carboxylic acid (e) is added to the elastomeric composition in an amount of from 0.5 phr to 10 phr, preferably from 1.0 phr to 5.0 phr.

According to one preferred embodiment, the diene elastomeric polymer (a) which may be used in the present invention may be selected from those commonly used in sulphur-crosslinkable elastomeric compositions, that are particularly suitable for producing tyres, that is to say from elastomeric polymers or copolymers with an unsaturated chain having a glass transition temperature (T_{g}) generally below 20° C., preferably in the range of from 0° C. to −100° C. These polymers or copolymers may be of natural origin or may be obtained by solution polymerization, emulsion polymerization or gas-phase polymerization of one or more conjugated diolefins, optionally blended with at least one comonomer selected from monovinylarenes and/or polar comonomers in an amount of not more than 60% by weight.

The conjugated diolefins generally contain from 4 to 12, preferably from 4 to 8 carbon atoms, and may be chosen, for example, from the group comprising: 1,3-butadiene, isoprene, 2,3-dimethyl-1,3-butadiene, 1,3-pentadiene, 1,3-hexadiene, 3-butyl-1,3-octadiene, 2-phenyl-1,3-butadiene, or mixtures thereof. 1,3-butadiene and isoprene are particularly preferred.

Monovinylarenes which may optionally be used as comonomers generally contain from 8 to 20, preferably from 8 to 12 carbon atoms, and may be chosen, for example, from: styrene; 1-vinylnaphthalene; 2-vinylnaphthalene; various alkyl, cycloalkyl, aryl, alkylaryl or arylalkyl derivatives of styrene such as, for example, α-methylstyrene, 3-methylstyrene, 4-propylstyrene, 4-cyclohexylstyrene, 4-dodecylstyrene, 2-ethyl-4-benzylstyrene, 4-p-tolylstyrene, 4-(4-phenylbutyl)styrene, or mixtures thereof. Styrene is particularly preferred.

Polar comonomers which may optionally be used may be chosen, for example, from: vinylpyridine, vinylquinoline, acrylic acid and alkylacrylic acid esters, nitriles, or mixtures thereof, such as, for example, methyl acrylate, ethyl acrylate, methyl methacrylate, ethyl methacrylate, acrylonitrile, or mixtures thereof.

Preferably, the diene elastomeric polymer (a) which may be used in the present invention may be chosen, for example, from: cis-1,4-polyisoprene (natural or synthetic, preferably natural rubber), 3,4-polyisoprene, polybutadiene (in particular polybutadiene with a high 1,4-cis content), optionally halogenated isoprene/isobutene copolymers, 1,3-butadiene/acrylonitrile copolymers, styrene/1,3-butadiene copolymers, styrene/isoprene/1,3-butadiene copolymers, styrene/1,3-butadiene/acrylonitrile copolymers, or mixtures thereof.

The elastomeric composition according to the present invention may optionally comprise at least one elastomeric polymer of one or more monoolefins with an olefinic comonomer or derivatives thereof (a′). The monoolefins may be selected from: ethylene and α-olefins generally containing from 3 to 12 carbon atoms, such as, for example, propylene, 1-butene, 1-pentene, 1-hexene, 1-octene, or mixtures thereof. The following are preferred: copolymers between ethylene and an α-olefin, optionally with a diene; isobutene homopolymers or copolymers thereof with small amounts of a diene, which are optionally at least partially halogenated. The diene optionally present generally contains from 4 to 20 carbon atoms and is preferably selected from: 1,3-butadiene, isoprene, 1,4-hexadiene, 1,4-cyclohexadiene, 5-ethylidene-2-norbornene, 5-methylene-2-norbornene, vinylnorbornene, or mixtures thereof. Among these, the following are particularly preferred: ethylene/propylene copolymers (EPR) or ethylene/propylene/diene copolymers (EPDM); polyisobutene; butyl rubbers; halobutyl rubbers, in particular chlorobutyl or bromobutyl rubbers; or mixtures thereof.

A diene elastomeric polymer (a) or an elastomeric polymer (a′) functionalized by reaction with suitable terminating agents or coupling agents may also be used. In particular, the diene elastomeric polymers obtained by anionic polymerization in the presence of an organometallic initiator (in particular an organolithium initiator) may be functionalized by reacting the residual organometallic groups derived from the initiator with suitable terminating agents or coupling agents such as, for example, imines, carbodiimides, alkyltin halides, substituted benzophenones, alkoxysilanes or aryloxysilanes (see, for example, European patent EP 451,604, or patents U.S. Pat. No. 4,742,124 and U.S. Pat. No. 4,550,142).

According to one preferred embodiment, the reinforcing filler (b) which may be used in the present invention may be selected from those commonly used for crosslinked manufactured products, in particular in the production of tyres, that is to say from carbon black, silica, alumina, aluminosilicates, calcium carbonate, kaolin, or mixtures thereof.

The types of carbon black which may be used according to the present invention may be selected from those conventionally used in the production of tyres, generally having a surface area of not less than 20 m²/g (determined by CTAB absorption as described in ISO standard 6810).

The silica which may be used according to the present invention may generally be a pyrogenic silica or, preferably, a precipitated silica, with a BET surface area (measured according to ISO standard 5794/1) of from 50 m²/g to 500 m²/g, preferably from 70 m²/g to 200 m²/g.

When a reinforcing filler comprising silica is present, the elastomeric composition may advantageously incorporate a coupling agent capable of interacting with the silica and of linking it to the elastomeric base during the vulcanization.

Coupling agents that are preferably used are those based on silane which may be identified, for example, by the following structural formula (I):
(R′)₃Si—CₙH₂ₙ—X (I)
in which the groups R′, which may be identical or different from each other, are selected from: alkyl, alkoxy or aryloxy groups or from halogen atoms, on condition that at least one of the groups R′ is an alkoxy or aryloxy group; n is an integer between 1 and 6 inclusive; X is a group selected from: nitroso, mercapto, amino, epoxide, vinyl, imide, chloro, —(S)ₘCₙH₂ₙ—Si—(R)₃ in which m and n are integers between 1 and 6 inclusive and the groups R are defined as above.

Among the coupling agents that are particularly preferred are bis(3-triethoxysilylpropyl)tetrasulphide and bis(3-triethoxysilylpropyl)disulphide. Said coupling agents may be used as such or as a suitable mixture with an inert filler (for example carbon black) so as to facilitate their incorporation into the elastomeric composition.

According to one preferred embodiment, said reinforcing filler (b) is added to the elastomeric composition in an amount of from 0.1 phr to 120 phr, preferably from 20 phr to 90 phr.

According to one preferred embodiment, the fatty acid amide (d) which may be used in the present invention may be selected from compounds having the following formulae (II) or (III): 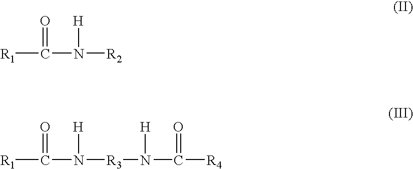
wherein:
R₁ and R₄, which may be identical or different from each other, are selected from linear or branched C₁-C₂₄ alkyl groups, linear or branched C₂-C₂₄ alkenyl groups, C₅-C₂₄ cycloalkyl groups;
R₃ is a linear or branched C₁-C₁₀ alkylene group;
R₂ is hydrogen; or is selected from linear or branched C₁-C₂₄ alkyl groups, linear or branched C₂-C₂₄ alkenyl groups, C₅-C₂₄ cycloalkyl groups.

Specific examples of fatty acid amides are: acetamide, propionamide, n-butyramide, n-valeramide, n-caproamide, stearamide, lauroylamide, miristic amide, arachidamide, behenamide, ethylene-bis-stearamide, ethylene-bis-oleamide, or mixtures thereof. Stearamide is particularly preferred.

The fatty acid amides (d) may be obtained by the reaction of a fatty acid, or its acid chloride or ester, with ammonia or an amine or a diamine. More details relating to said process may be found, for example, in “Encyclopedia of Chemical Technology”, Kirk-Othmer, Third Edition, Vol. 2, John Wiley & Sons, New York, 1978, pages 252-257 and in “Organic Chemistry”, Fieser and Fieser, D.C. Heath and Company, Boston, 1944, pages 183-184, 232 and 242.

Examples of fatty acid amides (d) which may be used in the present invention and which are currently commercially available are the products Crodamides® from Croda.

According to one preferred embodiment, the carboxylic acids of formula R—COOH may be selected from: C₈-C₁₀ coconout acid, stearic acid, lauric acid, oleic acid, octanoic acid, myristic acid, palmitic acid, palmitoleic acid, linoleic acid, benzoic acid, chlorobenzoic acid, methylbenzoic acid, naphthyl acid.

The zinc salt of a carboxylic acid (e) may be obtained by mixing zinc oxide, zinc hydroxide or zinc carbonate with carboxylic acids having formula R—COOH. This process may be carried out as disclosed, for example in U.S. Pat. No. 5,302,315.

Examples of zinc salts of carboxylic acids (e) which may be used in the present invention and which are currently commercially available are the products Polyplastol® 6 from Great Lakes Corp., Aktiplast® PP from Rhein-Chemie, Struktol® A50L or A50P from Schill & Seilacher.

The elastomeric composition according to the present invention may be vulcanized according to known techniques, in particular with sulphur-based vulcanizing systems commonly used for diene elastomeric polymers. To this end, in the composition, after a thermomechanical working step, a sulphur-based vulcanizing agent is incorporated together with vulcanization accelerators. During the last mentioned working step, the temperature is generally kept below 120° C. and preferably below 100° C., so as to avoid any undesired pre-cross-linking phenomena.

The vulcanizing agent most advantageously used is sulphur, or molecules containing sulphur (sulphur donors), with accelerators and activators known to those skilled in the art.

Besides the zinc oxide, other activators may be present in the elastomeric composition according to the present invention. Said activators may be selected from fatty acids (e.g. stearic acid) and also from other oxides such as, for example, BiO, PbO, Pb₃O₄, PbO₂, or mixtures thereof.

Accelerators that are commonly used may be selected from: dithiocarbamates, guanidine, thiourea, thiazoles, sulphenamides, thiurams, amines, xanthates, or mixtures thereof.

The elastomeric composition according to the present invention may comprise other commonly used additives chosen on the basis of the specific application for which the composition is intended. For example, the following may be added to said composition: antioxidants, anti-ageing agents, plasticizers, adhesives, anti-ozone agents, modifying resins, fibres (for example Kevlar® pulp), or mixtures thereof.

In particular, for the purpose of further improving the processability, a plasticizer generally selected from mineral oils, vegetable oils, synthetic oils, or mixtures thereof, such as, for example, aromatic oil, naphthenic oil, phthalates, soybean oil, or mixtures thereof, may be added to the elastomeric composition according to the present invention. The amount of plasticizer generally ranges from 2 phr to 100 phr, preferably from 5 phr to 50 phr.

The elastomeric composition according to the present invention may be prepared by mixing together the polymeric components with the reinforcing filler and with the other additives optionally present according to techniques known in the art. The mixing may be carried out, for example, using an open mixer of open-mill type, or an internal mixer of the type with tangential rotors (Banbury) or with interlocking rotors (Intermix), or in continuous mixers of Ko-Kneader type (Buss) or of co-rotating or counter-rotating twin-screw type or on a two-roll-mill.

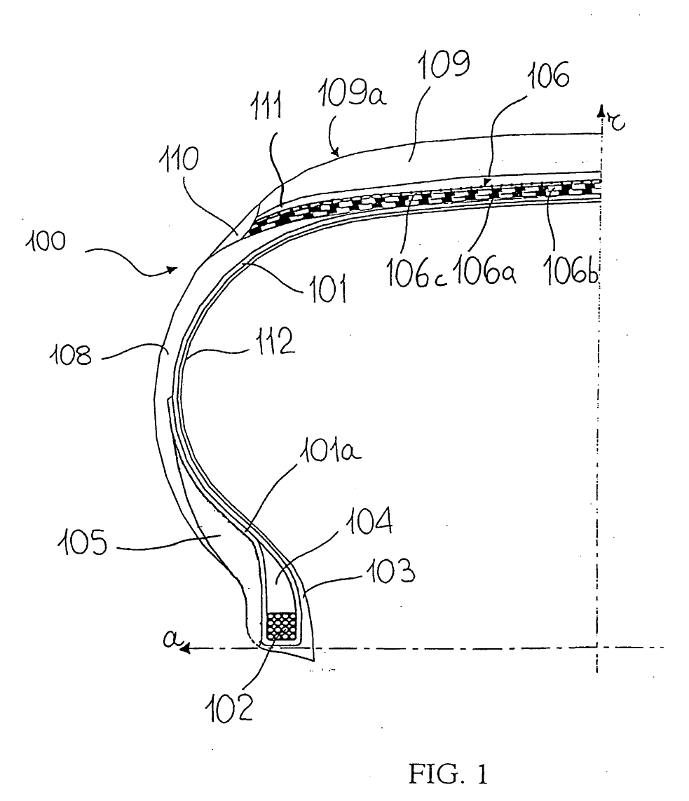

The present invention will now be illustrated in further detail by means of a number of illustrative embodiments, with reference to the attached FIG. 1, which is a view in cross section of a portion of a tyre made according to the invention.

“a” indicates an axial direction and “r” indicates a radial direction. For simplicity, FIG. 1 shows only a portion of the tyre, the remaining portion not represented being identical and symmetrically arranged with respect to the radial direction “r”.

The tyre (100) comprises at least one carcass ply (101), the opposite lateral edges of which are associated with respective bead wires (102). The association between the carcass ply (101) and the bead wires 1102) is achieved here by folding back the opposite lateral edges of the carcass ply (101) around the bead wires (102) so as to form the so-called carcass back-folds (101a) as shown in FIG. 1.

Alternatively, the conventional bead wires (102) can be replaced with a pair of circumferentially inextensible annular inserts formed from elongate components arranged in concentric coils (not represented in FIG. 1) (see, for example, European patent applications EP 928,680 and EP 928,702). In this case, the carcass ply (101) is not back-folded around said annular inserts, the coupling being provided by a second carcass ply (not represented in FIG. 1) applied externally over the first.

The carcass ply (101) generally consists of a plurality of reinforcing cords arranged parallel to each other and at least partially coated with a layer of elastomeric compound. These reinforcing cords are usually made of textile fibres, for example rayon, nylon or polyethylene terephthalate, or of steel wires stranded together, coated with a metal alloy (for example copper/zinc, zinc/manganese, zinc/molybdenum/cobalt alloys and the like).

The carcass ply (101) is usually of radial type, i.e. it incorporates reinforcing cords arranged in a substantially perpendicular direction relative to a circumferential direction. Each bead wire (102) is enclosed in a bead (103), defined along an inner circumferential edge of the tyre (100), with which the tyre engages on a rim (not represented in FIG. 1) forming part of a vehicle wheel. The space defined by each carcass back-fold (101a) contains a bead filler (104) in which the bead wires (102) are embedded. An antiabrasive strip (105) is usually placed in an axially external position relative to the carcass back-fold (101a).

A belt structure (106) is applied along the circumference of the carcass ply (101). In the particular embodiment in FIG. 1, the belt structure (106) comprises two belt strips (106a, 106b) which incorporate a plurality of reinforcing cords, typically metal cords, which are parallel to each other in each strip and intersecting with respect to the adjacent strip, oriented so as to form a predetermined angle relative to a circumferential direction. On the radially outermost belt strip (106b) may optionally be applied at least one zero-degree reinforcing layer (106c), commonly known as a “0° belt”, which generally incorporates a plurality of reinforcing cords, typically textile cords, arranged at an angle of a few degrees relative to a circumferential direction, and coated and welded together by means of an elastomeric material.

A side wall (108) is also applied externally onto the carcass ply (101), this side wall extending, in an axially external position, from the bead (103) to the end of the belt structure (106).

A tread band (109), whose lateral edges are connected to the side walls (108), is applied circumferentially in a position radially external to the belt structure (106). Externally, the tread band (109), which can be produced according to the present invention, has a rolling surface (109a) designed to come into contact with the ground. Circumferential grooves which are connected by transverse notches (not represented in FIG. 1) so as to define a plurality of blocks of various shapes and sizes distributed over the rolling surface (109a) are generally made in this surface (109a), which is represented for simplicity in FIG. 1 as being smooth.

A strip made of elastomeric material (110), commonly known as a “mini-side wall”, may optionally be present in the connecting zone between the side walls (108) and the tread band (109), this mini-side wall generally being obtained by co-extrusion with the tread band and allowing an improvement in the mechanical interaction between the tread band (109) and the side walls (108). Alternatively, the end portion of the side wall (108) directly covers the lateral edge of the tread band (109). A underlayer which forms, with the tread band (109), a structure commonly known as a “cap and base” (not represented in FIG. 1) may optionally be placed between the belt structure (106) and the tread band (109).

A layer of elastomeric material (111) which serves as an “attachment sheet”, i.e. a sheet capable of providing the connection between the tread band (109) and the belt structure (106), may be placed between the tread band (109) and the belt structure (106).

In the case of tubeless tyres, a rubber layer (112) generally known as a “liner”, which provides the necessary impermeability to the inflation air of the tyre, may also be provided in a radially internal position relative to the carcass ply (101).

The process for producing the tyre according to the present invention can be carried out according to techniques and using apparatus that are known in the art, as described, for example, in patents EP 199,064, U.S. Pat. No. 4,872,822, U.S. Pat. No. 4,768,937, said process including at least one stage of manufacturing the green tyre and at least one stage of vulcanizing this tyre.

More particularly, the process for producing the tyre comprises the stages of preparing, beforehand and separately from each other, a series of semi-finished products corresponding to the various parts of the tyre (carcass plies, belt structure, bead wires, fillers, side walls and tread band) which are then combined together using a suitable manufacturing machine. Next, the subsequent vulcanization stage welds the abovementioned semi-finished products together to give a monolithic block, i.e. the finished tyre.

Naturally, the stage of preparing the abovementioned semi-finished products will be preceded by a stage of preparing and moulding the various blends, of which said semi-finished products are made, according to conventional techniques.

The green tyre thus obtained is then passed to the subsequent stages of moulding and vulcanization. To this end, a vulcanization mould is used which is designed to receive the tyre being processed inside a moulding cavity having walls which are countermoulded to define the outer surface of the tyre when the vulcanization is complete.

Alternative processes for producing a tyre or parts of a tyre without using semi-finished products are disclosed, for example, in the abovementioned patent applications EP 928,680 and EP 928,702.

The green tyre can be moulded by introducing a pressurized fluid into the space defined by the inner surface of the tyre, so as to press the outer surface of the green tyre against the walls of the moulding cavity. In one of the moulding methods widely practised, a vulcanization chamber made of elastomeric material, filled with steam and/or another fluid under pressure, is inflated inside the tyre closed inside the moulding cavity. In this way, the green tyre is pushed against the inner walls of the moulding cavity, thus obtaining the desired moulding. Alternatively, the moulding can be carried out without an inflatable vulcanization chamber, by providing inside the tyre a toroidal metal support shaped according to the configuration of the inner surface of the tyre to be obtained as decribed, for example, in patent EP 242,840. The difference in coefficient of thermal expansion between the toroidal metal support and the crude elastomeric material is exploited to achieve an adequate moulding pressure.

At this point, the stage of vulcanizing the crude elastomeric material present in the tyre is carried out. To this end, the outer wall of the vulcanization mould is placed in contact with a heating fluid (generally steam) such that the outer wall reaches a maximum temperature generally of between 100° C. and 230° C. Simultaneously, the inner surface of the tyre is heated to the vulcanization temperature using the same pressurized fluid used to press the tyre against the walls of the moulding cavity, heated to a maximum temperature of between 100° C. and 250° C. The time required to obtain a satisfactory degree of vulcanization throughout the mass of the elastomeric material can vary in general between 3 min and 90 min and depends mainly on the dimensions of the tyre. When the vulcanization is complete, the tyre is removed from the vulcanization mould.

Although the present invention has been illustrated specifically in relation to a tyre, other crosslinked elastomeric manufactured products that can be produced according to the invention may be, for example, conveyor belts, driving belts or flexible tubes.

The present invention will be further illustrated below by means of a number of preparation examples, which are given for purely indicative purposes and without any limitation of this invention.

### EXAMPLES 1-4

Preparation of the Elastomeric Compositions

The elastomeric compositions given in Table 1 were prepared as follows (the amounts of the various components are given in phr).

All the ingredients, except for the sulphur, the TBBS and the PVI, were mixed together in an internal mixer of the type with tangential rotors (Banbury) for about 5 min (1^{st} Stage). As soon as the temperature reached 145±5° C., the elastomeric composition was discharged. The sulphur, the TBBS and the PVI were then added and mixing was carried out on a two-roll mill (2^{nd} Stage).

TABLE 1

EXAMPLES

| | | | |
|---|---|---|---|
| 1 (*) | 2 (*) | 3 (*) | 4 |

1^{st} STAGE

| | | | | |
|---|---|---|---|---|
| NR | 60.0 | 60.0 | 60.0 | 60.0 |
| BR | 40.0 | 40.0 | 40.0 | 40.0 |
| Carbon black | 55.0 | 55.0 | 55.0 | 55.0 |
| Stearic acid | 1.0 | 1.0 | 1.0 | 1.0 |
| Zinc oxide | 3.5 | 3.5 | 3.5 | 3.5 |
| Polyplastol ® 6 | — | 2.0 | — | 2.0 |
| Wax | 1.0 | 1.0 | 1.0 | 1.0 |
| Aromatic oil | 5.0 | 5.0 | 5.0 | 5.0 |
| Crodamide ® SR | — | — | 2.0 | 2.0 |
| 6PPD | 3.0 | 3.0 | 3.0 | 3.0 |

2^{nd} STAGE

| | | | | |
|---|---|---|---|---|
| TBBS | 1.7 | 1.7 | 1.7 | 1.7 |
| PVI | 0.2 | 0.2 | 0.2 | 0.2 |
| Sulphur | 1.2 | 1.2 | 1.2 | 1.2 |

(*) comparative.
NR: natural rubber;
BR: cis-1,4-polybutadiene (Europrene ® Neocis BR40 - EniChem Elastomeri);
Carbon black: N115 (Vulcan ® 9 - Cabot);
Polyplastol ® 6: mixture of zinc salts of fatty acids (palmitic acid, stearic acid and oleic acid being present in major amount) (Great Lakes Chemical Corp.);
Wax: composition of microcrystalline wax (Antilux ® 654 - Bayer);
Crodamide ® SR: stearamide (Croda);
6PPD (anti-ageing agent): N-1,3-dimethylbutyl-N′-p-phenylendiamine (Vulkanox ® 4020 - Bayer);
TBBS (accelerator): N-t-butyl-2-benzothiazyl-sulphenamide (Vulkacit ® NZ - Bayer);
PVI (retardant): N-cyclohexylthiophthalimide (Santogard ® PVI - Monsanto).

The Mooney viscosity ML(1+4) at 100° C. was measured, according to ISO standard 289/1, on the non-crosslinked compositions obtained as described above. The results obtained are given in Table 2.

The following properties were measured on samples of said elastomeric compositions crosslinked at 170° C. for 10 minutes:
tensile mechanical properties at 23° C. according to ISO standard 37 (CA1=stress at 100% elongation; CA3=stress at 300% elongation; S.B.=stress at break;
E.B.=elongation at break);
hardness in IHRD degree at 23° C. according to ISO standard 48;
rebound at 23° C. according to ISO standard 4662;
abraded volume at 23° C. according to DIN standard 53516 expressed as relative volumetric loss with respect to the reference composition of Example 1 (set at 100).

The results obtained are given in Table 2.

TABLE 2

EXAMPLES

| | 1 (*) | 2 (*) | 3 (*) | 4 |
|---|---|---|---|---|
| Mooney | — | 99.80 | 110.20 | 89.00 |
| Viscosity | | | | |
| (ML1 + 4) | | | | |
| CA 1 (MPa) | 2.72 | 2.74 | 2.68 | 2.74 |
| CA 3 (MPa) | 13.83 | 13.68 | 13.40 | 13.31 |
| S.B. (MPa) | 21.72 | 21.68 | 21.65 | 21.61 |
| E.B. (%) | 451.50 | 454.80 | 468.10 | 465.80 |
| IRHD hardness | 75.20 | 76.00 | 76.20 | 77.00 |
| at 23° C. | | | | |
| Rebound (%) | 49.00 | 47.00 | 46.20 | 46.20 |
| DIN abrasion | 100 | 94 | 115 | 110 |
| (index) | | | | |

(*): comparative.

The results given in Table 2 show that the elastomeric composition according to the present invention (Example 4) has a lower Mooney Viscosity value and, consequently, an improved processability. Moreover, the crosslinked manufactured product obtained from said elastomeric composition shows a better abrasion resistance. Said results have been obtained without impairing the mechanical properties of the crosslinked manufactured product.

### EXAMPLES 5-8

Preparation of the Elastomeric Compositions

The elastomeric compositions given in Table 3 were prepared as follows (the amounts of the various components are given in phr).

All the ingredients, except for the zinc oxide, the sulphur, the 6PPD, the DPG80 and the CBS, were mixed together in an internal mixer of the type with tangential rotors (Banbury) for about 5 min (1^{st} Stage). As soon as the temperature reached 145±5° C., the elastomeric composition was discharged. Then zinc oxide and 6PPD were added and mixing was carried out in an internal mixer of the type with tangential rotors (Banbury) for about 4 min (2^{nd} Stage). As soon as the temperature reached 125±5° C., the elastomeric composition was discharged Then the sulphur, the DPG80 and the CBS were added and mixing was carried out in a two-roll mill (3^{rd} Stage).

TABLE 3

EXAMPLES

| | | | |
|---|---|---|---|
| 5 (*) | 6 (*) | 7 (*) | 8 |

1^{st} STAGE

| | | | | |
|---|---|---|---|---|
| BR | 25.0 | 25.0 | 25.0 | 25.0 |
| SBR | 75.0 | 75.0 | 75.0 | 75.0 |
| Silica | 65.0 | 65.0 | 65.0 | 65.0 |
| Silane | 10.0 | 10.0 | 10.0 | 10.0 |
| Polyplastol ® 6 | — | 2.0 | — | 2.0 |
| Crodamide ® SR | — | — | 2.0 | 2.0 |
| Stearic acid | 2.0 | 2.0 | 2.0 | 2.0 |
| Wax | 1.0 | 1.0 | 1.0 | 1.0 |
| Aromatic oil | 5.0 | 5.0 | 5.0 | 5.0 |

2^{nd} STAGE

| | | | | |
|---|---|---|---|---|
| Zinc oxide | 2.5 | 2.5 | 2.5 | 2.5 |
| 6PPD | 2.0 | 2.0 | 2.0 | 2.0 |

3^{rd} STAGE

| | | | | |
|---|---|---|---|---|
| DPG80 | 2.2 | 2.2 | 2.2 | 2.2 |
| CBS | 1.6 | 1.6 | 1.6 | 1.6 |
| Sulphur | 1.0 | 1.0 | 1.0 | 1.0 |

(*) comparative.
BR: cis-1,4-polybutadiene (Europrene ® Neocis BR40 - EniChem Elastomeri);
SBR: styrene/butadiene copolymer, obtained by emulsion polymerization, containing 25% by weight of styrene, mixed with 37.5 phr of oil (SBR 5025 - Bayer);
Silica: precipitated silica (Ultrasil ® VN3 - Degussa);
Silane: bis(3-triethoxysilylpropyl)tetrasulphide (product X50S containing 50% carbon black and 50% silane - Degussa) (the amounts given in Table 3 refer only to the silane);
Polyplastol ® 6: mixture of zinc salts of fatty acids (palmitic acid, stearic acid and oleic acid being present in major amount) (Great Lakes Chemical Corp.);
Crodamide ® SR: stearamide (Croda);
Wax: composition of microcrystalline wax (Antilux ® 654 - Bayer);
6PPD (anti-ageing agent): N-1,3-dimethylbutyl-N′-p-phenylendiamine (Vulkanox ® 4020 - Bayer);
DPG80 (accelerator): predispersed 80% diphenyl-guanidine (Bayer);
CBS (accelerator): N-cyclohexyl-2-benzothiazyl-sulphenamide (Santocure ® - Monsanto).

The Mooney viscosity ML(1+4) at 100° C. was measured, according to ISO standard 289/1, on the non-crosslinked compositions obtained as described above. The results obtained are given in Table 4.

The following properties were measured on samples of said elastomeric compositions crosslinked at 170° C. for 10 minutes:
tensile mechanical properties at 23° C. according to ISO standard 37 (CA1=stress at 100% elongation; CA3=stress at 300% elongation; S.B.=stress at break; E.B.=elongation at break);
hardness in IHRD degree at 23° C. according to ISO standard 48;
rebound at 23° C. according to ISO standard 4662;
abraded volume at 23° C. according to DIN standard 53516 expressed as relative volumetric loss with respect to the reference composition of Example 5 (set at 100).

The results obtained are given in Table 4.

TABLE 4

EXAMPLES

| | 5 (*) | 6 (*) | 7 (*) | 8 |
|---|---|---|---|---|
| Mooney Viscosity | 100.50 | 79.90 | 95.70 | 83.30 |
| (ML1 + 4) | | | | |
| CA 1 (MPa) | 2.36 | 2.30 | 2.52 | 2.47 |
| CA 3 (MPa) | 11.19 | 10.59 | 11.55 | 11.13 |
| S.B. (MPa) | 17.81 | 16.04 | 16.88 | 14.49 |
| E.B. (%) | 454.50 | 443.70 | 432.50 | 397.00 |
| IRHD hardness | 76.80 | 74.50 | 76.40 | 74.30 |
| at 23° C. | | | | |
| Rebound (%) | 34.00 | 34.00 | 34.40 | 33.20 |
| DIN abrasion | 100 | 85 | 105 | 106 |
| (index) | | | | |

(*): comparative.

The results given in Table 4 show that the elastomeric composition according to the present invention (Example 8) has a lower Mooney Viscosity value and, consequently, an improved processability. Moreover, the crosslinked manufactured product obtained from said elastomeric composition shows a better abrasion resistance. Said results have been obtained without impairing the mechanical properties of the crosslinked manufactured product.

1-44. (canceled)

45. A tyre for a vehicle wheel, comprising:
at least one structural element including a crosslinked elastomeric material obtained by crosslinking an elastomeric composition comprising:
at least one diene elastomeric polymer;
at least one reinforcing filler;
from 0.05 phr to 10 phr of zinc oxide;
from 0.1 phr to 20 phr of at least one fatty acid amide; and
from 0.1 phr to 15 phr of at least one zinc salt of a carboxylic acid of formula R—COOH, wherein R is selected from linear or branched C₁-C₂₄ alkyl groups, linear or branched C₂-C₂₄ alkenyl groups, C₅-C₂₄ cycloalkyl groups, C₆-C₂₄ aryl groups, C₇-C₂₄ alkylaryl or arylalkyl groups.

46. The tyre of claim 45, comprising:
a carcass structure;
a belt structure applied in a circumferentially external position relative to the carcass structure;
a tread band superimposed circumferentially on the belt structure; and
a pair of sidewalls applied laterally on opposite sides relative to the carcass structure;
wherein the carcass structure comprises at least one carcass ply,
wherein the at least one carcass ply is shaped in a substantially toroidal configuration,
wherein opposite lateral edges of the carcass structure are associated with respective bead wires,
wherein each bead wire is enclosed in a respective bead,
wherein the belt structure comprises at least one belt strip, and
wherein the at least one structural element including the crosslinked elastomeric material is the tread band.

47. The tyre of claim 45, wherein the elastomeric composition comprises from 0.1 phr to 6.0 phr of the zinc oxide.

48. The tyre of claim 45, wherein the elastomeric composition comprises from 0.5 phr to 5.0 phr of the zinc oxide.

49. The tyre of claim 45, wherein the elastomeric composition comprises from 0.5 phr to 10 phr of the at least one fatty acid amide.

50. The tyre of claim 45, wherein the elastomeric composition comprises from 2.0 phr to 6.0 phr of the at least one fatty acid amide.

51. The tyre of claim 45, wherein the elastomeric composition comprises from 0.5 phr to 10 phr of the at least one zinc salt of a carboxylic acid.

52. The tyre of claim 45, wherein the elastomeric composition comprises from 1.0 phr to 5.0 phr of the at least one zinc salt of a carboxylic acid.

53. The tyre of claim 45, wherein the at least one diene elastomeric polymer has a glass transition temperature (T_{g}) below 20° C.

54. The tyre of claim 45, wherein the at least one diene elastomeric polymer comprises one or more of: cis-1,4-polyisoprene; 3,4-polyisoprene; polybutadiene; optionally halogenated isoprene/isobutene copolymers; 1,3-butadiene/acrylonitrile copolymers; styrene/1,3-butadiene copolymers; styrene/isoprene/1,3-butadiene copolymers; and styrene/1,3-butadiene/acrylonitrile copolymers.

55. The tyre of claim 45, wherein the elastomeric composition further comprises at least one elastomeric polymer of one or more monoolefins with an olefinic comonomer or derivatives thereof.

56. The tyre of claim 54, wherein the at least one elastomeric polymer of one or more monoolefins comprises one or more of: ethylene/propylene copolymers (EPR) or ethylene/propylene/diene copolymers (EPDM); polyisobutene; butyl rubbers; and halobutyl rubbers.

57. The tyre of claim 45, wherein the at least one reinforcing filler comprises one or more of: carbon black; silica; alumina; aluminosilicates; calcium carbonate; and kaolin.

58. The tyre of claim 45, wherein the at least one reinforcing filler comprises carbon black.

59. The tyre of claim 45, wherein the at least one reinforcing filler comprises silica.

60. The tyre of claim 45, wherein the elastomeric composition comprises from 0.1 phr to 120 phr of the at least one reinforcing filler.

61. The tyre of claim 45, wherein the elastomeric composition comprises from 20 phr to 90 phr of the at least one reinforcing filler.

62. The tyre of claim 45, wherein the at least one fatty acid amide is selected from compounds having the following formulae (II) or (III): 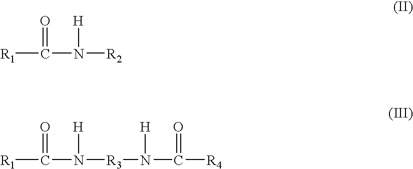
wherein R₁ and R₄, which may be identical or different from each other, are selected from linear or branched C₁-C₂₄ alkyl groups, linear or branched C₂-C₂₄ alkenyl groups, C₅-C₂₄ cycloalkyl groups;
wherein R₃ is a linear or branched C₁-C₁₀ alkylene group; and
wherein R₂ is hydrogen or is selected from linear or branched C₁-C₂₄ alkyl groups, linear or branched C₂-C₂₄ alkenyl groups, or C₅-C₂₄ cycloalkyl groups.

63. The tyre of claim 62, wherein the at least one fatty acid amide comprises one or more of: acetamide, propionamide, n-butyramide, n-valeramide, n-caproamide, stearamide, lauroylamide, miristic amide, arachidamide, behenamide, ethylene-bis-stearamide, and ethylene-bis-oleamide.

64. The tyre of claim 62, wherein the at least one fatty acid amide comprises stearamide.

65. The tyre of claim 45, wherein the carboxylic acid of formula R—COOH comprises one or more of: C₈-C₁₀ coconout acid; stearic acid; lauric acid; oleic acid; octanoic acid; myristic acid; palmitic acid; palmitoleic acid; linoleic acid; benzoic acid; chlorobenzoic acid; methylbenzoic acid; and naphthyl acid.

66. A tyre tread band including a crosslinkable elastomeric composition, the composition comprising:
at least one diene elastomeric polymer;
at least one reinforcing filler;
from 0.05 phr to 10 phr of zinc oxide;
from 0.1 phr to 20 phr of at least one fatty acid amide; and
from 0.1 phr to 15 phr of at least one zinc salt of a carboxylic acid of formula R—COOH, wherein R is selected from linear or branched C₁-C₂₄ alkyl groups, linear or branched C₂-C₂₄ alkenyl groups, C₅-C₂₄ cycloalkyl groups, C₆-C₂₄ aryl groups, C₇-C₂₄ alkylaryl or arylalkyl groups.

67. The tyre tread band of claim 66, wherein the elastomeric composition comprises from 0.1 phr to 6.0 phr of the zinc oxide.

68. The tyre tread band of claim 66, wherein the zinc oxide (c) is added to the elastomeric composition in an amount of from 0.5 phr to 5.0 phr.

69. The tyre tread band of claim 66, wherein the elastomeric composition comprises from 0.5 phr to 10 phr of the at least one fatty acid amide.

70. The tyre tread band of claim 66, wherein the elastomeric composition comprises from 2.0 phr to 6.0 phr of the at least one fatty acid amide.

71. The tyre tread band of claim 66, wherein the elastomeric composition comprises from 0.5 phr to 10 phr of the at least one zinc salt of a carboxylic acid.

72. The tyre tread band of claim 66, wherein the elastomeric composition comprises from 1.0 phr to 5.0 phr of the at least one zinc salt of a carboxylic acid.

73. The tyre tread band of claim 66, wherein the at least one diene elastomeric polymer comprises one or more of: cis-1,4-polyisoprene; 3,4-polyisoprene; polybutadiene; optionally halogenated isoprene/isobutene copolymers; 1,3-butadiene/acrylonitrile copolymers; styrene/1,3-butadiene copolymers; styrene/isoprene/1,3-butadiene copolymers; and styrene/1,3-butadiene/acrylonitrile copolymers.

74. The tyre tread band of claim 66, wherein the at least one reinforcing filler comprises one or more of: carbon black; silica; alumina; aluminosilicates; calcium carbonate; and kaolin.

75. The tyre tread band of claim 66, wherein the at least one fatty acid amide is selected from compounds having the following formulae (II) or (III): 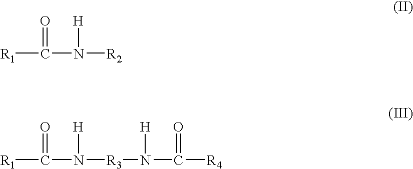
wherein R₁ and R₄, which may be identical or different from each other, are selected from linear or branched C₁-C₂₄ alkyl groups, linear or branched C₂-C₂₄ alkenyl groups, C₅-C₂₄ cycloalkyl groups;
wherein R₃ is a linear or branched C₁-C₁₀ alkylene group; and
wherein R₂ is hydrogen or is selected from linear or branched C₁-C₂₄ alkyl groups, linear or branched C₂-C₂₄ alkenyl groups, or C₅-C₂₄ cycloalkyl groups.

76. The tyre tread band of claim 66, wherein the carboxylic acid of formula R—COOH comprises one or more of: C₈-C₁₀ coconout acid; stearic acid; lauric acid; oleic acid; octanoic acid; myristic acid; palmitic acid; palmitoleic acid; linoleic acid; benzoic acid; chlorobenzoic acid; methylbenzoic acid; and naphthyl acid.

77. An elastomeric composition, comprising:
at least one diene elastomeric polymer;
at least one reinforcing filler;
from 0.05 phr to 10 phr of zinc oxide;
from 0.1 phr to 20 phr of at least one fatty acid amide; and
from 0.1 phr to 15 phr of at least one zinc salt of a carboxylic acid of formula R—COOH, wherein R is selected from linear or branched C₁-C₂₄ alkyl groups, linear or branched C₂-C₂₄ alkenyl groups, C₅-C₂₄ cycloalkyl groups, C₆-C₂₄ aryl groups, C₇-C₂₄ alkylaryl or arylalkyl groups.

78. The elastomeric composition of claim 77, comprising from 0.1 phr to 6.0 phr of the zinc oxide.

79. The elastomeric composition of claim 77, comprising from 0.5 phr to 5.0 phr of the zinc oxide.

80. The elastomeric composition of claim 77, comprising from 0.5 phr to 10 phr of the at least one fatty acid amide.

81. The elastomeric composition of claim 77, comprising from 2.0 phr to 6.0 phr of the at least one fatty acid amide.

82. The elastomeric composition of claim 77, comprising from 0.5 phr to 10 phr of the at least one zinc salt of a carboxylic acid.

83. The elastomeric composition of claim 77, comprising from 1.0 phr to 5.0 phr of the at least one zinc salt of a carboxylic acid.

84. The elastomeric composition of claim 77, wherein the at least one diene elastomeric polymer comprises one or more of: cis-1,4-polyisoprene; 3,4-polyisoprene; polybutadiene; optionally halogenated isoprene/isobutene copolymers; 1,3-butadiene/acrylonitrile copolymers; styrene/1,3-butadiene copolymers; styrene/isoprene/1,3-butadiene copolymers; and styrene/1,3-butadiene/acrylonitrile copolymers.

85. The elastomeric composition of claim 77, wherein the at least one reinforcing filler comprises one or more of: carbon black; silica; alumina; aluminosilicates; calcium carbonate; and kaolin.

86. The elastomeric composition of claim 77, wherein the at least one fatty acid amide is selected from compounds having the following formulae (II) or (III): 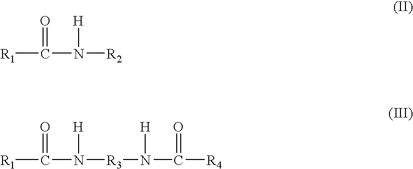
wherein R₁ and R₄, which may be identical or different from each other, are selected from linear or branched C₁-C₂₄ alkyl groups, linear or branched C₂-C₂₄ alkenyl groups, C₅-C₂₄ cycloalkyl groups;
wherein R₃ is a linear or branched C₁-C₁₀ alkylene group; and
wherein R₂ is hydrogen or is selected from linear or branched C₁-C₂₄ alkyl groups, linear or branched C₂-C₂₄ alkenyl groups, or C₅-C₂₄ cycloalkyl groups.

87. The elastomeric composition of claim 77, wherein the carboxylic acid of formula R—COOH comprises one or more of: C₈-C₁₀ coconout acid; stearic acid; lauric acid; oleic acid; octanoic acid; myristic acid; palmitic acid; palmitoleic acid; linoleic acid; benzoic acid; chlorobenzoic acid; methylbenzoic acid; and naphthyl acid.

88. A crosslinked elastomeric manufactured product obtained by crosslinking the elastomeric composition of claim 77.
